(19) United States
(12) Patent Application Publication
(10) Pub. No.: US 2018/0305253 A1
(43) Pub. Date: Oct. 25, 2018

(54) METHOD FOR PRODUCING HIGHLY REACTIVE CEMENTS

(71) Applicant: HeidelbergCement AG, Heidelberg (DE)

(72) Inventors: Mohsen BEN HAHA, Heidelberg (DE); Tim LINK, Luenen (DE); Frank BELLMANN, Weimar (DE); Horst-Michael LUDWIG, Weimar (DE)

(73) Assignee: HeidelbergCement AG, Heidelberg (DE)

(21) Appl. No.: 15/580,038

(22) PCT Filed: Jun. 8, 2016
(86) PCT No.: PCT/EP2016/000942

§ 371 Date: Dec. 6, 2017

(30) Foreign Application Priority Data
Jun. 16, 2015 (EP) 15001774.7

(51) Int. Cl. C04B 7/345; C04B 7/43; C04B 28/18; C04B 28/02

(52) U.S. Cl. CPC C04B 7/3453; C04B 28/025; C04B 28/188; C04B 7/43

(57) ABSTRACT

The invention relates to a method for producing cements by hydrothermally treating a starting material containing sources of CaO and SiO₂ in an autoclave at a temperature of 100 to 300° C., and tempering the obtained intermediate product at 350 to 700° C., wherein water formed during tempering is dissipated by grinding the intermediate product and/or tempering taking place under a continuous gas stream. The invention also relates to cements obtained in this manner, hydraulic binders therefrom, and building materials which contain said binders.

The present invention relates to a method for producing highly reactive cements by means of hydrothermal treatment and tempering of starting materials, as well as cements and binders therefrom and construction materials that contain these.

Cements, which can be obtained by means of hydrothermal treatment and subsequent tempering, are known as such. To this end EP 2 676 943 A1 describes a method for producing belite cement having high reactivity, in which a starting material made of raw materials is provided, which have a molar Ca/Si ratio of 1.5 to 2.5, the starting material is treated hydrothermally in the autoclave at a temperature of 100 to 300° C. and a residence time of 0.1 to 24 h, wherein the water/solid ratio is from 0.1 to 100, the intermediate product obtained thereby is tempered at 350 to 495° C., wherein the heating rate is 10-6000° C./min and the residence time is 0.01 to 600 min, and wherein, during mixing and/or in the following steps, 0.1 to 30% by weight of additional elements and/or oxides are added. Further methods can be found in the documents mentioned in this document as prior art.

Such cements have the advantage of releasing substantially less carbon dioxide during production than Portland cement, calcium aluminate cement and other classic cements. Very many side products and waste products are suitable as the raw material. These cements are thus ecologically advantageous.

If the tempering is carried out at temperatures of e.g. less than 500° C. in methods as described above, a particularly big, energetic advantage emerges; furthermore, many of the components in the cement are more reactive than when higher temperatures are used for tempering. The disadvantage is that, under certain settings, only low reactivities can be obtained. These settings are 1. a certain grain shape and surface characteristic of the intermediate product obtained by means of the hydrothermal treatment, 2. tempering of very large amounts of intermediate product and 3. tempering in sealed containers.

According to EP 2 243 754 A1, a particularly reactive product can be obtained by means of hydrothermal treatment of starting materials containing Ca and Si and reactive grinding of the product. Yet a grinding, with which an activation in the sense of a chemical conversion can be obtained, requires a lot of energy. In addition, a very high fineness of the product is also associated with a sufficient reaction; cement produced in such a way has a high water demand or, without water reducing agent, does not produce any useful strength.

The object of the production of highly reactive cements with as low an energy requirement as possible is thus not yet completely solved.

Surprisingly, it was now found that the reactivity of the belite in cements, which are obtained by means of hydrothermal treatment of a starting material and tempering, can be increased when water split off during tempering is quickly removed. A quick removal of the water vapour is achieved, on the one hand, by means of a grinding of the intermediate product obtained by means of the hydrothermal treatment. The change of the grain characteristic improves the gas flow of the expelled water. On the other hand, a quick removal is achieved by the tempering being carried out under a continuous gas flow or adjusting a high surface to volume ratio of the intermediate product during tempering.

The invention thus solves the above object through a method for producing cements by means of hydrothermal treatment of a starting material, which contains sources for CaO and SiO₂, in an autoclave at a temperature of from 100 to 300° C., and tempering the obtained intermediate product at 350 to 700° C., preferably up to 495° C., wherein water formed during tempering is removed by grinding the intermediate product and/or carrying out the tempering under a continuous gas flow. The object is further solved by means of cements and hydraulic binders therefrom, obtainable by means of hydrothermal treatment of a starting material, which contains sources for CaO and SiO₂, in an autoclave at a temperature of from 100 to 300° C., and tempering the obtained intermediate product at 350 to 700° C., wherein water formed during tempering is removed.

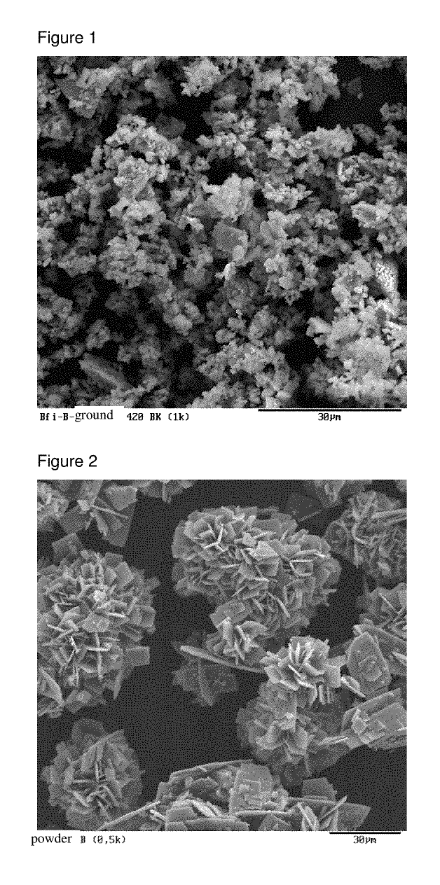

The end product obtained after tempering, if necessary, ground to a common cement fineness, displays a very high reactivity. Scanning electron microscopic experiments show that grinding the intermediate product influences not only the particle size, but also the surface structure. In FIG. 1, the end product obtained with grinding according to the invention is shown; in FIG. 2, a product obtained without removing the water by grinding or gas flow during tempering is shown. With the product obtained according to the invention, the particles are smaller, and the packing density is higher. The reactivity of this product is substantially higher; a better processability emerges. But also the phase composition is influenced by the quick removal of the water vapour, the content of γ C₂S decreases, instead more x C₂S forms. The reactivity and partially also the proportion of X-ray amorphous phases increases.

The following abbreviations that are common in the cement industry are used: H—H₂O, C—CaO, A—Al₂O₃, F—Fe₂O₃, M—MgO, S—SiO₂ and $—S0₃. In order to simplify the further description, generally, compounds are stated in their pure form, without explicitly stating solid solution series/substitutions by foreign ions etc., as are common in technical and industrial materials. As is understood by every person skilled in the art, the composition of the phases nominally stated in this invention can vary depending on the chemism of the raw meal and the kind of production, as a result of the substitution with various foreign ions, wherein such compounds also fall inside the scope of protection of the present invention and shall be comprised by stating the pure phases/compounds.

For the present invention, clinker means a sintering product which is obtained by means of burning a raw material mixture at an increased temperature and contains at least one hydraulically reactive phase. A clinker, ground with or without the addition of further components, is called cement, as is an equally fine-grained material obtained in a different manner, which reacts hydraulically after mixing with water. Binder or binder mixture designates a hydraulically hardening mixture, which contains cement and typically, but not necessarily, further finely ground components, and which is used after the addition of water, optionally admixtures and aggregate. Unless otherwise stated, “reactive” means a hydraulic reactivity.

The cement according to the invention is produced by means of hydrothermal treatment of a starting material made of one or more raw materials, which provide sufficient quantities of CaO and SiO₂. Here, on the one hand, pure or substantially pure raw materials, such as calcium hydroxide or oxide and quartz powder or microsilica, are suitable. On the other hand, a plurality of natural but also industrial materials, such as, for example, but not exclusively, limestone, bauxite, clay/claystone, calcined clays (e.g. metakaolin), basalts, periodites, dunites, ignimbrites, carbonatites, ashes/slags/ground granulated blast furnace slags of high and low quality (in terms of mineralogy/glass content, reactivity, etc.), diverse stockpile materials, red and brown muds, natural sulphate carriers, desulphurisation muds, phosphogypsum, flue gas gypsum, titanogypsum, fluorogypsum, etc., are used as the starting material in a suitable combination. Substances/substance groups that are not nominally stated, which meet the minimum chemical requirements as potential raw materials, fall under the scope of protection.

Raw materials that contain both SiO₂ and CaO are particularly preferred, such that the desired ratio Ca/Si is already present. If the desired Ca/Si ratio is not present, then the raw materials must be adjusted in terms of the chemical composition before further treatment by adding further reaction partners such as solids containing Ca or Si to a suitable Ca:Si ratio in the starting material, that is generally from 1.5 to 2.5. To do so, portlandite Ca(OH)₂, for example, or calcined or uncalcined lime are suitable. Generally, the raw materials or the starting material are optimised in terms of particle size and particle size distribution by means of mechanical or thermal treatment, wherein the thermal treatment can also lead to an optimisation of the chemical composition.

The preferred secondary raw materials also introduce further elements such as aluminium, iron, magnesium and others into the starting material mixture, in addition to sources for CaO and SiO₂. These are incorporated as foreign ions into the phases or form individual phases. If they are present, a molar (Ca+Mg)/(Si+Al+Fe) ratio of 1 to 3.5, a molar ratio Ca:Mg of 0.1 to 100 and a molar ratio (Al+Fe)/Si of 100 to 0.1 is preferred. The molar ratio of the sum of calcium and magnesium to the sum of silicon, aluminium and iron shall preferably be from 1.5 to 2.5, particularly preferred about 2. The ratio of calcium to magnesium is preferably from 0.2 to 20, particularly preferred from 0.5 to 5. The ratio of the sum of aluminium and iron to silicon is preferably 100 to 10 for a high aluminium content, 1 to 20 for an average aluminium content and 0.01 to 2 for a low aluminium content. When determining these ratios, those compounds that behave inertly during the production method are not taken into consideration.

In a preferred embodiment, fine grain material is chosen as the starting material, the largest grain of which being preferably no more than 0.1 mm. To do so, in particular the finer grain fractions from the reprocessing of binders containing cement in construction materials such as old concretes and old cements are used. A finer starting material is advantageous both in terms of the conversion speed and in terms of the effort for the grinding to produce the finished cement.

The starting material or the raw materials can be burnt in an additional step. This step is particularly preferred when using industrial side products or relatively low reactive or coarse materials as raw materials. Here, temperatures of from 400 to 1400° C., preferably from 750 to 1100° C., are suitable. The burning duration is 0.01 to 6 hours, preferably about 1 hour. In the flash calciner, 0.01 to 0.02 h are sufficient and preferred. Burning the starting material/raw materials results in the advantage that substances can be made useful in a targeted manner, which otherwise cannot or can hardly be used at all (e.g. crystal ashes, clays and slags etc.) by enabling an improved/greater convertibility in the autoclave to produce the intermediate product α-C₂SH (by deacidification and or dewatering . . . ). Furthermore, it also offers the advantage that precursor phases, (e.g. inert belite) can be produced, in a targeted manner which after the hydrothermal treatment and tempering comprise products having particularly high contents of x-C₂S, α-C₂S and/or at least one reactive, X-ray amorphous phase. The advantage of the use of belite as the raw material for the autoclave process is an improved phase composition of the final product in comparison to unburnt raw materials.

It is advantageous to add additional elements or oxides in an amount of 0.1 to 30% by weight to the starting material, e.g. when mixing the raw materials, or in one of the subsequent process steps. Sodium, potassium, boron, sulphur, phosphorous or combinations thereof are preferred as these additional elements/oxides which are also collectively referred to as foreign oxides. For this, alkaline and/or earth alkaline metal salts and/or hydroxides, for example CaSO₄.H₂O, CaSO₄.½H₂O, CaSO₄, CaNPO₂.2H₂O, Ca₃P₂O₈, NaOH, KOH, Na₂CO₃, NaHCO₃, K₂CO₃, MgCO₃, MgSO₄, Na₂Al₂O₄, Na₃PO₄, K₃PO₄, Na₂[B₄O₅(OH)₄]. 8H₂O etc. are suitable. In a preferred embodiment, the starting material has a molar ratio of P/Si of about 0.05 and/or S/Si of about 0.05 and/or Ca/K of about 0.05.

The starting material, optionally pre-treated as described, can advantageously be admixed, i.e. seeded, with seed crystals, which contain calcium silicate hydrates, Portland clinkers, ground granulated blast furnace slag, magnesium silicates, calcium sulphate aluminate (belite) cement, water glass, glass powder etc., for example. As a result, the reaction can be accelerated. Different compounds containing calcium silicate hydrate are suitable as seed crystals, in particular α-2CaO.SiO₂.H₂O, afwillite, calcio-chondrodite and β-Ca₂SiO₄. The amount is preferably from 0.01-30% by weight.

The starting material, which is optionally pre-treated and/or seeded as described above, is then subjected to a hydrothermal treatment in the autoclave at a temperature of from 100 to 300° C., preferably from 150 to 250° C. Herein, a water/solid ratio of 0.1 to 100, preferably of 2 to 20, is preferably chosen. The residence time is typically from 0.1 to 24 hours, preferably from 1 to 16 hours, in particular from 2 to 8 hours. The pressure during the hydrothermal treatment depends, above all, on the temperature and usually corresponds to the vapour pressure of water at the chosen temperature. By means of the hydrothermal treatment, the starting material is converted into an intermediate product containing at least one calcium silicate hydrate and optionally further compounds.

Surprisingly, laboratory tests showed that a water vapour atmosphere when tempering influences the reactivity and the phase composition of the cement end product. With higher sample quantities in the furnace or when using closed sample containers, the water vapour partial pressure significantly increases. The reactivity of the cement obtained decreases and the proportion of x-C₂S is reduced. According to the invention, a low water vapour partial pressure is thus set during the tempering. This can be achieved by grinding the intermediate product or removing the water vapour during tempering or, particularly prefered, by the combination of the two means.

According to the invention, the intermediate product is thus preferably ground. The grinding process can take place on both a wet and on a dried intermediate product. It was surprisingly found that a grinding of the intermediate product leads to significantly more reactive end products. However, no reaction grinding takes place, i.e. the supplied grinding energy is limited in such a way that substantially no chemical or mineralogical conversions are triggered. The object of the grinding is a deagglomeration and an improvement of the grain size range. It is assumed that thus the water expelled during tempering can escape more quickly.

The grinding can take place e.g. in a disc vibration mill, planet mill, ball mill, roller mill, material-bed roller mill or roll mill. The duration is preferably 0.1 to 30 minutes, in particular 0.5 to 10 minutes, and quite particularly preferred 1 to 5 minutes. The particle size distribution should be as wide as possible after grinding in order to ensure a good packing density.

The preferably ground intermediate product is tempered at a temperature of from 350° C. to 700° C., preferably at temperatures between 400° C. and 500° C. Higher temperatures when tempering, such as 500-700° C., are possible, yet they reduce the energetic advantage and the reactivity of phases, such as x-C₂S, for example, and the proportion of X-ray amorphous phase; thus, they are less preferred. Similarly, temperatures of 400° C. and below are less preferred, since the conversion takes longer or, in the case of particularly inert parts in the intermediate product, does not take place at all.

The heating rate is from 10-6000° C./min, preferably from 20-100° C./min and particularly preferred about 40° C./min. A residence time of 0.01-600 min, preferably from 1-120 min and particularly preferred from 5-60 min is suitable. An additional holding time of 1-120 min, preferably from 10-60 min, when heating at a temperature ranging from 400-440° C., has also proved of value for further decreasing the amount of the slow reacting γ-C₂S.

If no grinding of the intermediate product took place, and preferably also with a ground intermediate product, when tempering, a quick removal of the water vapour is ensured. A quick removal of the split off water when tempering is possible, for example, by means of a gas flow. In the simplest case, one lets an air flow pass over the material. Furthermore, the water can be removed by means of a negative pressure. A sufficiently large surface/volume ratio of the intermediate product when tempering, together with an open container, can also ensure a sufficiently quick removal. Yet this can only be implemented with difficultly on a large scale, thus a gas and, in particular, an air flow for removing the water is preferred.

The tempering takes place, for example, in a flash calciner or cyclone preheater or in the fluidised bed method. Since it is assumed that the CO₂ contents of the hot gas flow have a low influence on the binder quality, both a direct and an indirect firing is possible.

After cooling, the end product is obtained, which contains the desired reactive belite.

Besides the β C₂S predominant in Portland cement, polymorphs are known which have a higher reactivity, for example α, α′H, α′L and x C₂S, or a lower reactivity such as γ-C₂5, for example. Which polymorph forms depends, among other things, on the temperature. As a result of the method according to the invention, the reactive polymorphs are increasingly formed with the same starting materials, in comparison to the previously known hydrothermal production methods, and the formation of γ-C₂S is reduced. The end product according to the invention contains 20-100% of the following compounds: x-Ca₂SiO₄, X-ray amorphous compounds of variable composition, and p62 -Ca₂SiO₄, wherein the amount of γ-Ca₂SiO₄ is low, typically it is below 20% by weight, generally below 15% by weight and often below 10% by weight. The end product preferably contains x-Ca₂SiO₄ in an amount of >30% by weight and at least one X-ray amorphous phase with an amount of >5% by weight, wherein all contents of the end product add up to 100%.

Depending on the desired cement fineness, fineness of the starting material and, in particular, the fineness obtained when grinding the intermediate product, another grinding of the end product takes place to form the final cement, i.e. to a desired fineness or grain distribution. When grinding, grinding excipients can be added in a manner known as such for example alkanolamines, ethylene glycols or propylene glycols. These are used in the usual dosages, for example from 0.01 to 0.05% by weight.

The BET surface of the end product can be from 1 to 30 m²/g. The SiO₂ tetrahedrons in the end product have an average condensation degree of less than 1.0. The water content in the binder is less than 3.0% by weight.

The obtained cement according to the invention is suitable as a replacement for Portland cement and other classic cements in hydraulic binders.

Supplementary cementitious materials can also be mixed into the binder according to the invention. The amount proportions are very variable, preferably 5 to 95% by weight of supplementary cementitious material and 5 to 95% by weight of cement according to the invention are used. Preferred are 30 to 85% by weight of supplementary cementitious material and 15 to 70% by weight of cement, particularly preferred 40 to 80% by weight of supplementary cementitious material and 20 to 60% by weight of cement, wherein the values are based on the total amount of binder and the proportions with all further binder components add up to 100%.

Preferred supplementary cementitious materials are pozzolans and latent hydraulic materials, in particular tempered clays (e.g. metakaolin) and shale, V and W fly ashes, in particular those with a high glass content and/or content of reactive phases, ground granulated blast furnace slags and artificial (pozzolanic and latent hydraulic) glasses.

It is preferred that the binder also contains admixtures and/or additives, and optionally further hydraulically active components and/or sulphate carriers.

Additives are hydraulically non-active components, such as, but not exclusively, ground limestone/dolomite, precipitated CaCO₃, Mg(OH)₂, Ca(OH)₂, CaO, silica fume and glass powder. The additives can be dosed in sum in an amount ranging from 1 to 25% by weight, preferably from 3 to 20% by weight and yet more preferably from 6 to 15% by weight.

In a preferred embodiment, fillers, in particular rock flours such as limestone flour, are contained as additional main components. The amount here is very variable, preferably 5 to 95% by weight of filler and 5 to 95% by weight of cement according to the invention are used. Preferred are 30 to 85% by weight of filler and 15 to 70% by weight of cement, in particular 40 to 80% by weight of filler and 20 to 60% by weight of cement, wherein the values are based on the total amount of binder and the proportions with all further binder components add up to 100%.

In particular, alkali and/or earth alkali sulphates, preferably in the form of gypsum and/or hemihydrate and/or anhydrite and/or magnesium sulphate and/or sodium sulphate and/or potassium sulphate are suitable as the sulphate.

In a preferred embodiment, the binder contains at least one additional hydraulic material, preferably Portland cement. Here, the Portland cement can be both quantitatively predominant analogously to the Portland slag cements, and also, analogously to the blast furnace and composite cements, contain comparable amounts of Portland clinker and mixtures of latent hydraulic material with activator up to predominantly mixtures of latent hydraulic material with activator. Preferably, the binder can contain from 1 to 70% by weight, in particular from 5 to 40% by weight and particularly preferred from 10 to 25% by weight, of Portland cement.

The cement according to the invention, and optionally present additions, such as supplementary cementitious material, limestone and/or Portland cement clinkers and/or other clinkers and/or sulphate carriers, for example, are ground in the binder according to the invention to a fineness (according to Blaine) of 2000 to 20000 cm²/g, preferably from 3000 to 6000 cm²/g and particularly preferred from 4000 to 5000 cm²/g. The grinding can take place separately or together in a manner known as such.

Preferably, the cement or the binder mixture also contains admixtures, preferably one or more setting and/or hardening accelerators and/or concrete water reducing agents and/or plasticizers and/or retarders. Concrete water reducing agents and/or plasticizers and/or retarders are preferably those based on lignin sulphonates, sulphonated naphthalene, melamine or phenol formaldehyde condensate, or based on acrylic acid acrylamide mixtures or polycarboxylate ethers or based on phosphated polycondensates, phosphated alkyl carboxylic acids and salts thereof, (hydroxy)carboxylic acids and carboxylates, borax, boric acid and borates, oxalates, sulphanilic acid, amino carboxylic acids, salicylic acid and acetyl salicylic acid, as well as on dialdehydes. Furthermore, air entraining agents, water repellents, sealants, and/or stabilisers can be contained. The dosing of the admixtures takes place in the usual amounts.

The binder according to the invention can be used in an inherently known manner for all applications in which Portland cement, Portland foundry cement, composite cement etc. are otherwise used. Generally, the binder is mixed for use with aggregates and optionally further additions, to form e.g. concrete, mortar, plaster and screed, and mixed with water.

When processing the binder according to the invention, a water/binder value of 0.2 to 2 is suitable, preferably from 0.3 to 0.8 and particularly preferred from 0.35 to 0.5.

The invention shall be explained by means of the following examples, though without being limited to the specifically described embodiments. Unless otherwise stated or unless anything different necessarily emerges from the context, the percentages relate to the weight, in case of doubt to the total weight of the mixture.

The invention also relates to all combinations of preferred embodiments, as far as these are not mutually exclusive. The statements “about” or “approximate.” in connection with a number mean that values at least 10% higher or lower or values 5% higher or lower and, in any case, values 1% higher or lower are included.

### EXAMPLE 1

A starting material mixture was made of Ca(OH)₂ and highly dispersed SiO₂ was produced in a molar ratio of 2:1. After the addition of 5% by weight of α-2 CaO.SiO₂.H₂O as seed crystals, the mixture was homogenised with water. The ratio of water/solid was 10. An autoclave treatment at 200° C. for 16 h followed. Subsequently, a drying at 60° C. took place. The intermediate product contained 92% by weight of α-2CaO.SiO₂.H₂O, 2% by weight of calcite, and 6% by weight of amorphous components.

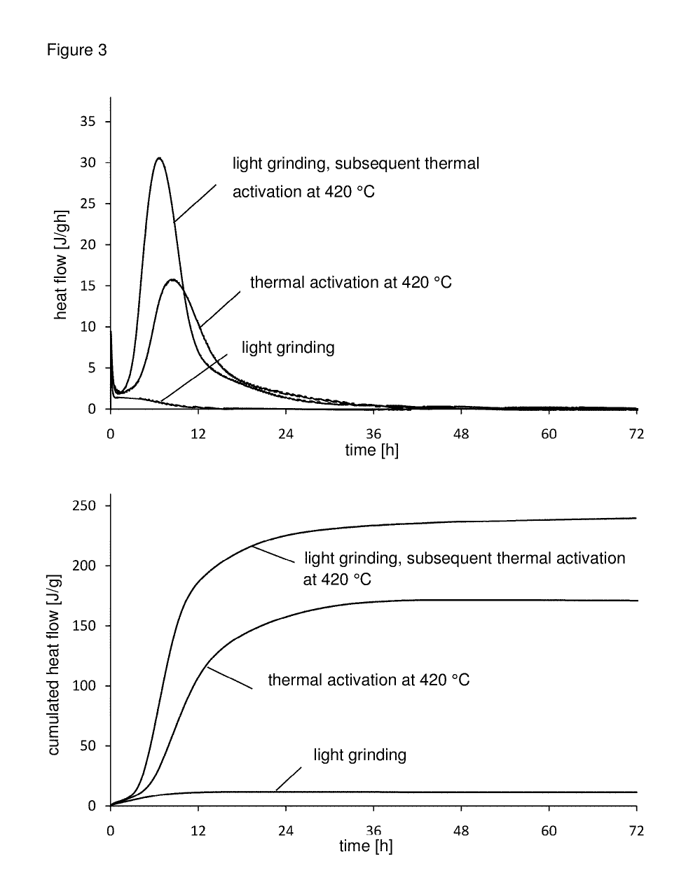

The dry intermediate product was ground in a disc vibration mill for 1 min. for improved removal of water during tempering. No change of the phase composition of the intermediate product was determined by X-ray, as a result of the grinding. The hydraulic activity of the ground intermediate product was checked by means of heat flow calorimetry. The result is depicted in FIG. 3. After initial low heat release, this product did not display any kind of hydraulic activity. Thus, an activation by means of the grinding is excluded; it is not a reactive grinding.

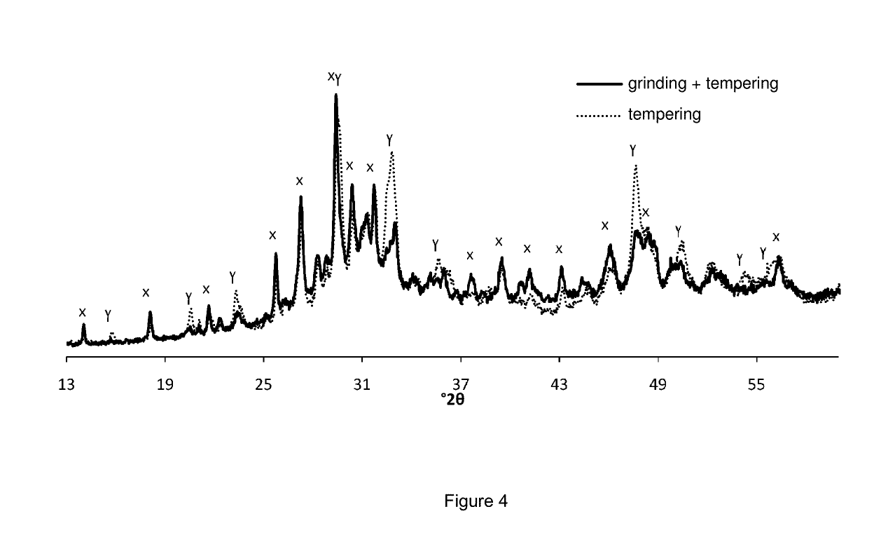

The ground intermediate product was then converted into an end product according to the invention by tempering at 420° C. The end product consisted of 30% by weight of x-Ca₂SiO₄, 3% by weight of γ-Ca₂SiO₄, 3% by weight of calcite and 64% by weight of X-ray amorphous material. The corresponding X-ray diffractogram is depicted in FIG. 4. The end product was examined in terms of the hydraulic reactivity by means of heat flow calorimetry. The results are also depicted in FIG. 3. A high hydraulic reactivity was proven. As a result of the light grinding, an increase of the heat amount by approx. 40% after 3 days was achieved (in comparison to comparative example 2). The binder according to the invention could be mixed and processed with a water/binder ratio of 0.4.

### COMPARATIVE EXAMPLE 2

The intermediate product from Example 1 was converted, without measures for removing water such as grinding or a gas flow, into an end product not according to the invention by tempering at 420° C. The end product consisted of 47% by weight of X-ray amorphous material, 30% by weight of x-Ca₂SiO₄, 20% by weight of γ-Ca₂SiO₄ and 3% by weight of calcite. The corresponding X-ray diffractogram is depicted in FIG. 3. The end product was examined in terms of the hydraulic reactivity by means of heat flow calorimetry. The results are also depicted in FIG. 4. The product not according to the invention shows a clearly lower heat release than the product according to the invention from Example 1. In order to mix the product to form a paste, a water/binder ratio of 1.5 was necessary.

### EXAMPLE 3

A starting material mixture was made of Ca(OH)₂ and nano-SiO₂ in the molar ratio of 2:1. After adding 5% by weight α-2CaO.SiO₂.H₂O as seed crystals, the mixture was homogenised with water. The ratio of water/solid was 2. An autoclave treatment at 200° C. for 16 h followed. Subsequently, drying at 60° C. took place. The intermediate product contained 93% by weight of α-2CaO.SiO₂.H₂O, 1% by weight of calcite, and 6% by weight of amorphous components.

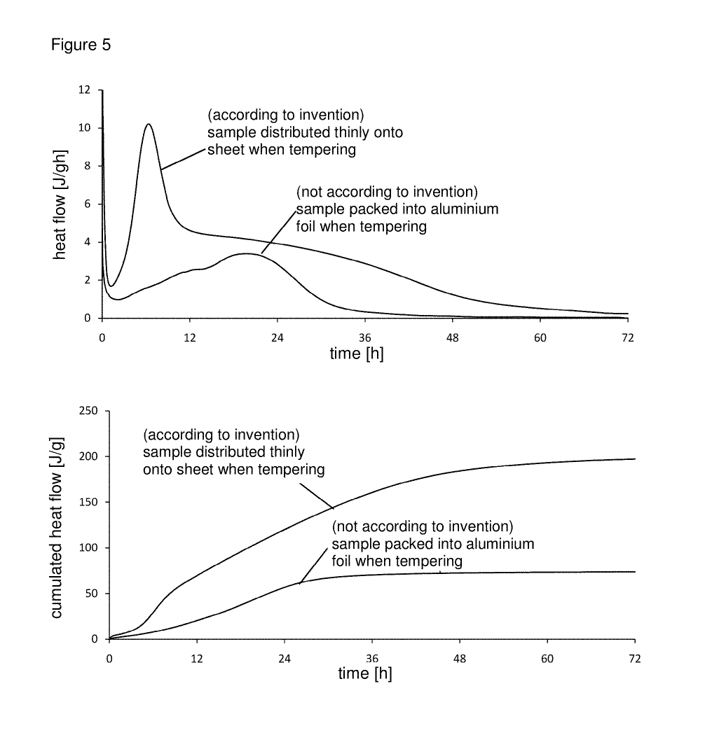

The dry intermediate product was spread on a steel sheet for improved removal of water during tempering with a layer thickness of approx. 1 mm, i.e. with high surface/volume ratio, and tempered in the muffle furnace at 420° C. for 1 hour. Subsequently, an increase of the temperature to 495° C. takes place. This temperature was maintained for 1 h. The water vapour expelled could thus quickly escape and a low water vapour partial pressure was ensured. The end product according to the invention consisted of 17% by weight of X-ray amorphous material, 63% by weight of x-Ca₂SiO₄, 8% by weight of γ-Ca₂SiO₄, 11% by weight of β-C₂S and 1% by weight of calcite. The end product was examined in terms of the hydraulic reactivity by means of heat flow calorimetry. The results are depicted in FIG. 5.

### COMPARATIVE EXAMPLE 4

The intermediate product from Example 3 was converted into a binder not according to the invention under increased water vapour partial pressure. For this, the intermediate product was wrapped by aluminium foil when tempering. This foil prevents a quick escape of the water vapour during tempering. Otherwise, the tempering took place as in Example 3. The product not according to the invention consisted of 17% by weight of X-ray amorphous material, 22% by weight of x-Ca₂SiO₄, 60% by weight of γ-Ca₂SiO₄ and 1% by weight of calcite. The end product was examined in terms of the hydraulic reactivity by means of heat flow calorimetry. The results are depicted in FIG. 5.

### EXAMPLE 5

A starting material mixture was made of Ca(OH)₂ and highly dispersed SiO₂ in the molar ratio of 2:1. After the addition as seed crystals of 5% by weight of α-2CaO.SiO₂.H₂O, the mixture was homogenised with water. The ratio of water/ solid was 10. An autoclave treatment with constant stirring at 200° C. for 16 h followed. Subsequently, a drying at 60° C. took place. The intermediate product contained of 87% by weight of α-2CaO.SiO₂.H₂O, 2% by weight of calcite, 2% by weight of scawtite and 9% by weight of amorphous components.

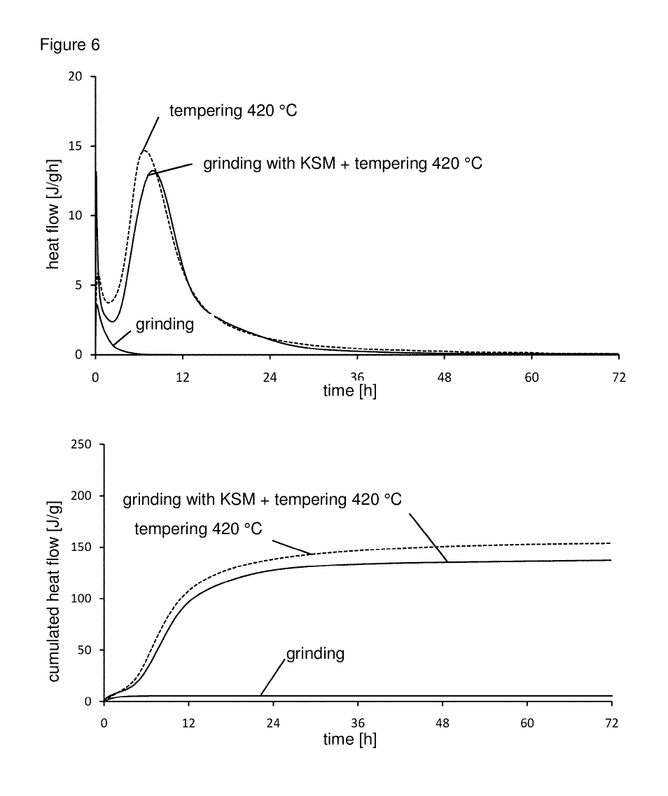

The dried intermediate product was mixed with 40% by weight of limestone flour (KSM) and ground in a planetary mill for 3 min. to improve the removal of water during tempering. Subsequently, a tempering at 420° C. took place. The result of measuring of the heat development by means of heat flow calorimetry is depicted in FIG. 6. Since limestone flour in this system can be considered to be inert, the reactivity of the end product is considerably increased as a result of the grinding together with limestone flour in comparison to the unground product (comparative example 6). The end product was able to be mixed with a water/binder ratio of 0.4 to form a paste.

The end product was examined in terms of the tensile strength development. The water/binder value (w/b) was set to 0.3 by using plasticizer. The strength was checked on cubes with an edge length of 4 cm. Strengths of 46 N/mm² emerged after 2 days, 46 N/mm² after 7% and 49 N/mm² after 28 days.

### COMPARATIVE EXAMPLE 6

The intermediate product from Example 5 was converted into an end product not according to the invention without grinding by tempering at 420° C. This consisted of 64% by weight of X-ray amorphous material, 7% by weight of x-Ca₂SiO₄, 23% by weight of γ-Ca₂SiO₄ and 5% by weight of calcite. The end product was examined in terms of the hydraulic reactivity by means of heat flow calorimetry. The results are depicted in FIG. 5. The end product not according to the invention requires a water/binder ratio of 1.4 in order to achieve a paste-like consistency.

1. Method for producing cement by means of hydrothermal treatment of a starting material, which includes sources for CaO and SiO₂, in an autoclave at a temperature of 100 to 300° C., and tempering the obtained intermediate product at 350 to 700° C.,
wherein
water formed during tempering is removed by the tempering taking place under a continuous gas flow to remove the water and/or the intermediate product being ground, in order to remove water formed during tempering.

2. The method according to claim 1, wherein the tempering takes place under a continuous gas flow to remove the water.

3. The method according to claim 1 wherein the tempering takes place at 400 to 495° C.

4. The method according to claim 1, wherein the intermediate product is ground for 0.1 to 30 minutes.

5. The method according to claim 4, wherein the grinding duration is 0.5 to 10 minutes, and in particular 1 to 5 minutes.

6. The method according to claim 1, wherein the grinding energy is limited in such a way that no or substantially no chemical and mineralogical conversions take place.

7. The method according to claim 1, wherein seed crystals containing calcium silicate hydrate, Portland clinker, ground granulated blast furnace slag, magnesium silicates, calcium sulphate aluminate (belite) cement, water glass, and/or glass powder are added for the hydrothermal treatment, preferably in an amount from 0.01 to 30% by weight.

8. The method according to claim 1, wherein, during tempering, during heating, a temperature ranging from 400 to 440° C. is maintained for 1 to 120 min.

9. The method according to claim 1, wherein, during tempering, a heating rate of 1 to 6000° C./rain and a residence time of 0.01 to 600 min are set.

10. Cement obtainable according to claim 1.

11. The cement according to claim 10, characterised in that wherein 20-100% of the following compounds are contained: x-Ca₂SiO₄, X-ray amorphous compounds of variable composition and β-Ca₂SiO₄.

12. The cement according to claim 11, wherein >30% by weight of x-Ca₂SiO₄ and >5% by weight of X-ray amorphous compounds, and <20% by weight of γ-Ca₂SiO₄ are contained.

13. The cement according to claim 10, wherein is has a fineness (according to Blaine) of 2000 to 20000 cm²/g, preferably from 3000 to 6000 cm²/g and particularly preferred from 4000 to 5000 cm²/g.

14. A hydraulic binder containing the cement according to claim 10 and at least one of supplementary cementitious materials, admixtures and additives.

15. The hydraulic binder according to claim 14, wherein 5 to 95% by weight of supplementary cementitious material and 5 to 95% by weight of cement, preferably 30 to 85% by weight of supplementary cementitious material and 15 to 70% by weight of cement, particularly preferred 40 to 80% by weight of supplementary cementitious material and 20 to 60% by weight of cement are included, wherein the values are based on the total amount of binder and the proportions with all further binder components add up to 100%.

16. The hydraulic binder according to claim 15, wherein the supplementary cementitious material is selected from pozzolans and latent hydraulic materials, in particular tempered clays (e.g. metakaolin) and shale, V and W fly ashes with high glass proportion and/or amount of reactive phases, ground granulated blast furnace slags and artificial (pozzolanic and latent hydraulic) glasses, and mixtures of two or more thereof.

17. The hydraulic binder according to claim 14, wherein additives in an amount ranging from 1 to 25% by weight, preferably from 3 to 20% by weight and yet more preferably 6 to 15% by weight are contained, preferably selected from ground limestone/dolomite, precipitated CaCO₃, Mg(OH)₂, Ca(OH)₂, CaO, silica fume, glass flour and mixtures thereof.

18. The hydraulic binder according to claim 14, wherein mixtures, preferably one or more setting and/or hardening accelerators and/or concrete water reducing agents and/or plasticizers and/or retarders are contained.

19. Construction material, in particular concrete, mortar, plaster, screed or joint sealant, containing the hydraulic binder according to claim 14, and aggregates.
